(19) United States
(12) Patent Application Publication
(10) Pub. No.: US 2024/0303728 A1
(43) Pub. Date: Sep. 12, 2024

(54) SYSTEMS AND METHODS FOR AUTOMATIC CREDIT LINE UNDERWRITING BASED ON GRANULAR BUDGETING DATA

(71) Applicant: Capital One Services, LLC, McLean, VA (US)

(72) Inventors: Xiaoguang ZHU, New York, NY (US); Evans YEUNG, Brooklyn, NY (US); Vyjayanthi VADREVU, Pflugerville, TX (US)

(21) Appl. No.: 18/118,874

(22) Filed: Mar. 8, 2023

(51) Int. Cl. G06Q 40/03

(52) U.S. Cl. CPC G06Q 40/03

(57) ABSTRACT

An automatic system including a server is provided. The server is configured to: upon receiving a bucket creation request from a user device, create one or more virtual budgeting buckets associated with a user account of a user of the user device; receive a certain amount of fund in at least one of the one or more virtual budgeting buckets; detect engagement data of the user with the one or more virtual budgeting buckets; determine, based on the engagement data, whether the user meets goals of the one or more virtual budgeting buckets; provide a predictive model; input the engagement data and completeness of the goals into the predictive model; determine a creditworthiness of the user based on the predictive model; and provide a credit line to the user based on the creditworthiness.

### FIELD OF THE INVENTION

The present disclosure relates generally to underwrite credit lines, and more particularly, to systems and methods for automatic credit line underwriting based on granular budgeting behavior data.

### BACKGROUND

The use of conventional creditworthiness data, such as a credit score, for credit underwriting decisions can create difficulties for consumers who are either new-to-credit and therefore have limited financial history or looking to rebuild credit. Because credit scores can be based on financial history with a lag in terms of data reflected in the score, and the scores can have limited predictive power for these consumers.

The possibility of using alternative data to credit scores exists. Alternative data, such as financial education via credit score simulator or watching video (videos watched by these consumers/users), can be helpful, but these alternative data are not directly linked to actual financial planning and money management activities.

These and other deficiencies exist. Accordingly, there is a need to provide systems and methods that can underwrite credit lines for consumers who are new-to-credit or needing to rebuild credit.

### SUMMARY

Aspects of the disclosed technology include systems and methods for automatic credit line underwriting based on granular budgeting data.

Embodiments of the present disclosure provide a system that can include a server. The server is configured to: upon receiving a bucket creation request from a user device, create one or more virtual budgeting buckets associated with a user account of a user of the user device; receive a certain amount of fund in at least one of the one or more virtual budgeting buckets; detect engagement data of the user with the one or more virtual budgeting buckets; determine, based on the engagement data, whether the user meets goals of the one or more virtual budgeting buckets; provide a predictive model; input the engagement data and completeness of the goals into the predictive model; determine a creditworthiness of the user based on the predictive model; and provide a credit line to the user based on the creditworthiness.

Embodiments of the present disclosure provide a method that comprises: upon receiving a bucket creation request from a user device, creating, by a server, one or more virtual budgeting buckets associated with a user account of a user of the user device; receiving, by the server, a certain amount of fund in at least one of the one or more virtual budgeting buckets; detecting, by the server, engagement data of the user with the one or more virtual budgeting buckets; determining, by the server based on the engagement data, whether the user meets goals of the one or more virtual budgeting buckets; providing, by the server, a predictive model; inputting, by the server, the engagement data and completeness of the goals into the predictive model; determining, by the server, a creditworthiness of the user based on the predictive model; and providing, by the server, a credit line to the user based on the creditworthiness.

Embodiments of the present disclosure provide a non-transitory, computer-accessible medium that comprises instructions that, when executed on a server, configure the server to perform actions comprising: upon receiving a bucket creation request from a user device, creating one or more virtual budgeting buckets associated with a user account of a user of the user device; receiving a certain amount of fund in at least one of the one or more virtual budgeting buckets; detecting engagement data of the user with the one or more virtual budgeting buckets; determining, based on the engagement data, whether the user meets goals of the one or more virtual budgeting buckets; providing a predictive model; inputting the engagement data and completeness of the goals into the predictive model; determining a creditworthiness of the user based on the predictive model; and providing a credit line to the user based on the creditworthiness.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for automatically underwriting credit lines based on granular budgeting behavior data according to an example embodiment.

FIG. 2 is a diagram illustrating interactions of components of the system of FIG. 1 according to an example embodiment.

FIG. 3 is a flow chart illustrating a method of automatically underwriting credit lines based on granular budgeting behavior data according to an example embodiment.

FIG. 4 is a diagram of a system for automatically underwriting credit lines based on granular budgeting behavior data according to an example embodiment.

FIG. 5 is a diagram of illustrating interactions of components of the system of FIG. 4 according to an example embodiment according to an example embodiment.

FIG. 6 is a flow chart illustrating a method of automatically underwriting credit lines based on granular budgeting behavior data according to an example embodiment.

FIG. 7 is a flow chart illustrating a method of determining a creditworthiness using a predictive model according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Example embodiments of the present disclosure provide systems and methods for automatically and continuously underwriting credit lines by leveraging granular budgeting behavior data, along with traditional creditworthiness data such as credit scores (e.g., a Fair Isaac Corporation (FICO) score), for consumers who are either new-to-credit, lacking a substantial credit history, or looking to rebuild credit.

As described above, use of conventional creditworthiness data, such as a credit score, for credit underwriting decisions can create difficulties for consumers who are either new-to-credit, have limited financial history, or need to rebuild credit. Because credit scores can be based on financial history with a lag in terms of data reflected in the score, and credit scores can have limited predictive power for these consumers.

Alternative data, such as financial education via credit score simulator or watching video (videos watched by these consumers/users), can be helpful. However, these alternative data are not directly linked to actual financial planning and money management activities, such as budgeting and timely bill-paying.

The present disclosure provides for systems and methods to use observed budgeting and saving behaviors from one or more virtual bucket features to continuously underwrite credit lines based on close to real-time behaviors (e.g., creating a bucket for emergencies and fund money in it). Leveraging a mental accounting model (such as virtual buckets) can help people manage money better.

One example embodiment of the present disclosure may enable consumers to create “virtual buckets” from checking accounts and set aside money in these savings and budgeting buckets. The systems and methods disclosed herein monitor if the consumers engage virtual bucket features (e.g., the number of times logging in to the virtual buckets, the number of buckets created, the types of buckets created such as emergency, rent, bill). The systems and methods disclosed herein further monitor if the consumers are able to meet their goals with fiscal discipline (e.g., how often they meet the goals, how much surplus or deficit they have with their goals or the target date of their goals). These daily observed engagement data with virtual buckets and completeness of goals can be fed into a predictive model (e.g. a machine learning (ML) model) to predict creditworthiness of the consumers, in conjunction with traditional model such as credit score data (e.g., FICO data). The consumers may be offered an initial credit line based on these behaviors/the predicted creditworthiness. The systems and methods disclosed herein continuously monitor virtual bucket behavior changes and spending behavior changes of the consumers, and feedback these changes to the ML model for iteration/refining the ML, thereby continuously adjusting the credit line based on behaviors of the consumers. For example, if the consumers maintain fiscal discipline with budgeting, the systems and methods disclosed herein can automatically reward the consumers with an higher credit line.

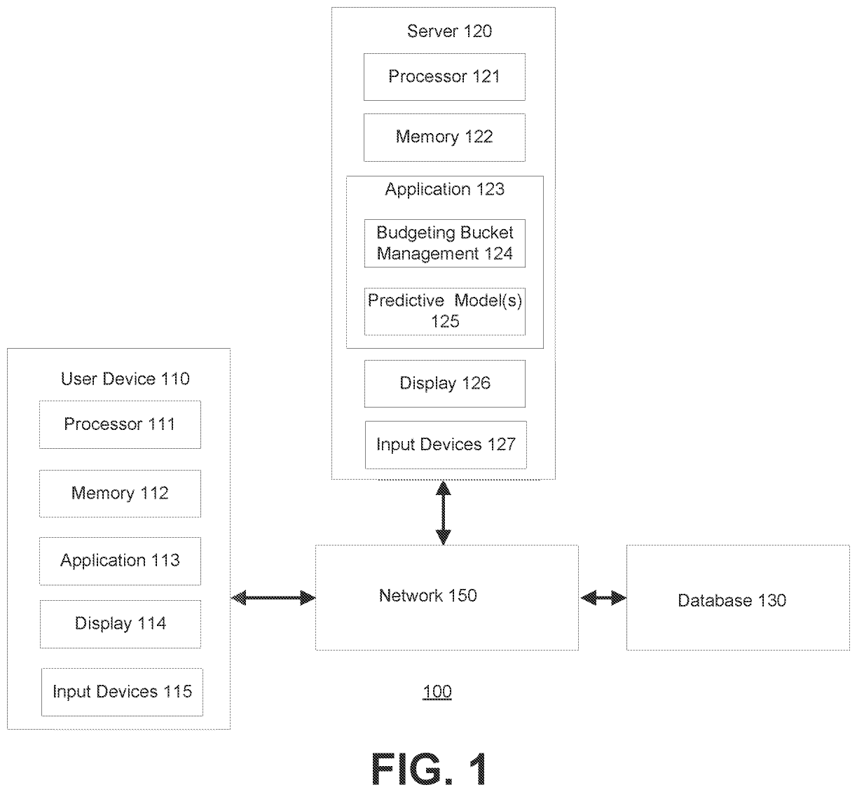

FIG. 1 illustrates a system 100 for automatically and continuously underwriting credit lines by leveraging granular budgeting behavior data, along with traditional creditworthiness data according to an example embodiment. As further discussed below, the system 100 may include a user device 110, a server 120, and a database 130 in communication using a network 150. Although FIG. 1 illustrates single instances of the components, the system 100 may include any number of components.

The user device 110 can be configured to present to a user interface from which the user may log into, for example, their bank or credit card account to access their transaction statement and virtual buckets stored in the database 130 of the server 120. The user device 110 may be configured to display on the user interface the transaction statement and/or virtual buckets, in response to a selection by the user. The server 120 may be associated with an institution, such as a financial institution, and can be configured to retrieve the transaction statement and/or virtual buckets from the database 130.

The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a smart card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 110 may include a processor 111, a memory 112, an application 113, a display 114, and input devices 115. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as application 113, and other data, such as private and personal information.

The application 113 may comprise one or more software applications comprising instructions for execution on the user device 110. In some examples, the user device 110 may execute one or more applications, such as software applications, that enable, for example, network communications with one or more components of the system 100, transmit and/or receive data, and perform the functions described herein such as presenting the transaction statement and/or virtual buckets to a user of the user device 110. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein such as selecting an option of viewing the transaction statement and/or virtual buckets.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a smart card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's shopping and financial account information.

The application 123 may comprise one or more software applications, such as budgeting bucket management 124 and predictive model(s) 125, comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. For example, the budgeting bucket management 124 of the application 123 may be executed to perform creating one or more virtual budgeting buckets and storing the one or more virtual budgeting buckets in the database 130; the predictive model(s) 125 of the application 123 may be executed to perform predict a creditworthiness of a user and provide a credit line based on the creditworthiness to the user, and store the creditworthiness and the credit line in the database 130. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 126 and input devices 127. The display 126 may be any type of device for presenting visual information such as a computer monitor, a flat panel display, and a mobile device screen, including liquid crystal displays, light-emitting diode displays, plasma panels, and cathode ray tube displays. The input devices 127 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

The database 130 may be one or more databases configured to store data, including without limitation, private information of users, financial accounts of users, virtual budgeting buckets, transactions of users, and credit lines of users. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 120.

The system 100 may include one or more networks 150. In some examples, the network 150 may be one or more of a wireless network, a wired network or any combination of wireless network and wired network, and may be configured to connect the user device 110, the server 120, and the database 130. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the user device 110, server 120, and database 130 using the network 150 can occur using one or more front channels and one or more secure back channels. A front channel may be a communication protocol that employs a publicly accessible and/or unsecured communication channel such that a communication sent to the user device 110, server 120, and/or database 130 may originate from any other device, whether known or unknown to the user device 110, server 120, and/or database 130, if that device possesses the address (e.g., network address, Internet Protocol (IP) address) of the user device 110, server 120, and/or database 130. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the user device 110, server 120, and/or database 130 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

In some examples, the user device 110 can be associated with a user and may be operated by that user, such as a consumer. The server 120 can be associated with a financial institution, such as a bank or a credit card company that offers financial services to the user of the user device 110.

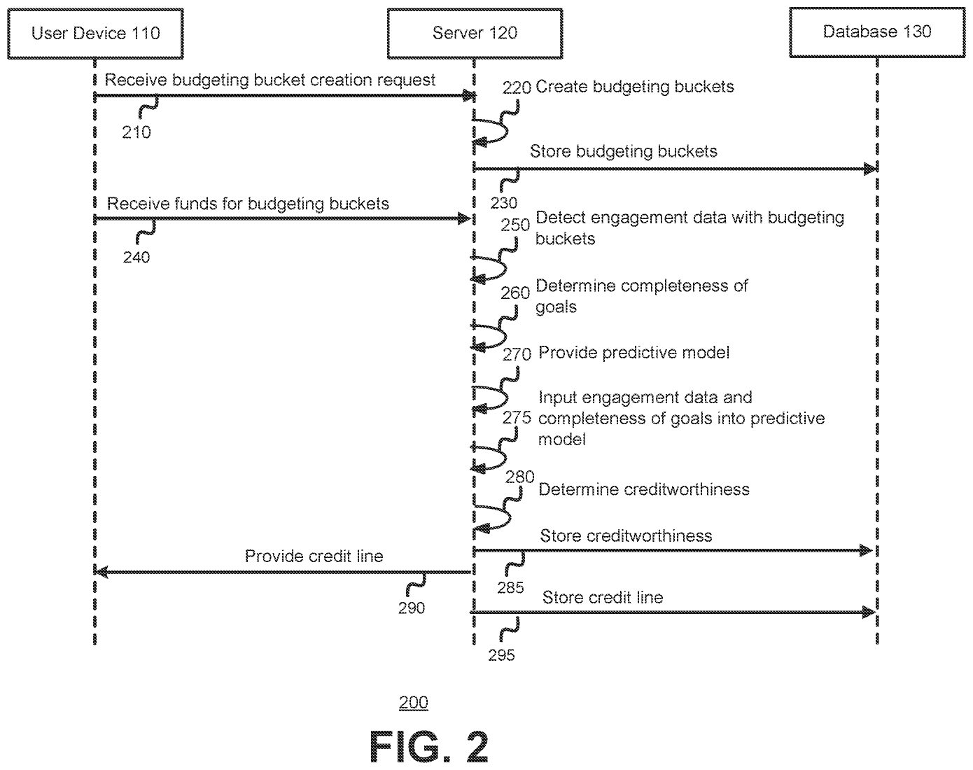

FIG. 2 illustrates a diagram illustrating interactions of components of the system of FIG. 1 according to an example embodiment. FIG. 2 may reference the same or similar components as those illustrated in FIG. 1, including a user device 110, a server 120, and a database 130.

When a user, for example, a bank consumer, may desire to create one or more virtual budgeting buckets as a potential budgeting tool, the user may transmit a budgeting bucket creation request from the user device 110 to the server 120, and accordingly at 210 the server 120 receives the request. The budgeting bucket creation request may include the number of buckets to be created and the type of the buckets to be created. The user may first be required to login to a financial account managed by the server 120 in an application installed on the user device 110, and then transmit the budgeting bucket creation request through the application to the server 120.

At 220, the server 120 creates one or more budgeting buckets according to the received request. For example, a first bucket is created and labeled as “emergency,” a second bucket is created and labeled as “medical bill,” a third bucket is created and labeled as “grocery,” and the like. These buckets are created under the financial account of the user and are associated with the financial account. At 230, the server 120 stores the created one or more budgeting buckets in the database 130 under the financial account of the user.

The user can set aside money for different purposes in the created budgeting buckets according to the names/labels of the budgeting buckets. At 240, the user may transmit funds to the server 120 through the application on the user device 110 for the buckets, and accordingly, the server 120 receives the funds for the buckets, and deposit/distribute the funds into the buckets. For example, the user may transmit $3,000 total and designate $2,000 towards a “vacation” bucket, and $1,000 towards an “emergency” bucket. In this way, the systems and methods disclosed herein can help the user be financially responsible or disciplined in terms of how the user spends his/her money.

Once the buckets are created and furnished with funds, at 250, the server 120 can monitor and detect engagement data of the user with the budgeting buckets. For example, the behavior data of the user's interactions with the buckets are monitored; how and when the user spends the money in the bucket is monitored; the way the user moves his/her different money into and/or out of the buckets is detected and evaluated; and the like.

At 260, the server 120 may determine completeness of financial goals of the buckets. The server 120 may monitor whether the user in fact achieves his/her budgeting goals, whether the funds in the buckets are surplus or deficit compared to the goals or the target date of the goals. For example, for a rent bucket, there may have a transaction history that demonstrates the rent is $2,000 a month and the rent bucket has $2,200 in it every month. At the end of every month there is a $2,000 withdrawal at the beginning of the next month, the goal can be considered as being met or surplus.

At 270, the server 120 provides a predictive model. The predictive model may be a machine learning model. The machine learning model employed can include at least one selected from the group of gradient boosting machine, logistic regression, neural networks, supervised learning, unsupervised learning, and a combination thereof, however, it is understood that other machine learning algorithms can be utilized.

The predictive models described herein can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that can not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The predictive models described herein can be trained on one or more training datasets, each of which can comprise one or more types of data. In some examples, the training datasets can comprise previously-collected data, such as data collected from previous uses of the same type of systems described herein and data collected from different types of systems. In other examples, the training datasets can comprise continuously-collected data based on the current operation of the instant system and continuously-collected data from the operation of other systems. In some examples, the training dataset can include anticipated data, such as the anticipated future events, currently scheduled events, and planned future events, for the instant system and/or other systems. In other examples, the training datasets can include previous predictions for the instant system and other types of system, and can further include results data indicative of the accuracy of the previous predictions. In accordance with these examples, the predictive models described herein can be trained prior to use and the training can continue with updated datasets that reflect additional information.

Examples of predictive models that may be implemented include a hidden Markov model, a Gaussian mixture model, a pattern matching algorithm, a neural network, a matrix representation, a vector quantization and decision tree, a supervised learning model, an unsupervised learning model, a semi-supervised learning model, a reinforcement learning model, a self-learning model, and a feature learning model.

At 275, the engagement data and the completeness of goals are fed into the predictive model by the server 120. For example, the number of times the suer logging in the buckets, how the user tweaks the buckets, and how actively the user is moving money in and out of certain buckets are all considered as indicators that the user is engaging with the buckets. The more the user engages, the more the user actually manages those budgeting buckets. The completeness of goals may include whether the user maintains a positive cash flow for one or more of the buckets.

At 280, the predictive model determines a creditworthiness for the user based on the engagement data and the completeness of goals. In some embodiments, the predictive model may combine the engagement data and the completeness of goals with the traditional credit scores (e.g., FICO score) and/or whether the user attends financial education to determine the creditworthiness.

At 285, the server 120 may store the determined creditworthiness in the database 130. At 290, the server 120 uses the predictive model to determine a credit line based on the creditworthiness for the user and provide the credit line to the user via the user device 110. For example, the credit line may be an initial credit line having a low credit limit. At 295, the server 120 may store the credit line in the database 130 and associate the credit line with the financial account of the user.

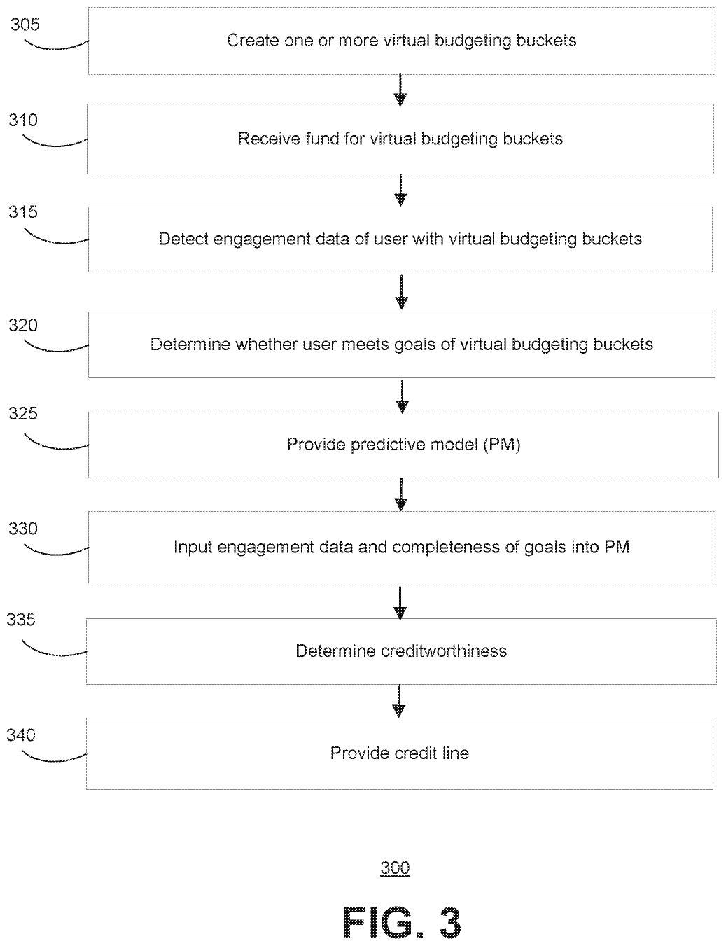

FIG. 3 is a flow chart illustrating a method 300 of automatically underwriting credit lines based on granular budgeting behavior data according to an example embodiment. FIG. 3 may reference the same or similar components as those illustrated in FIGS. 1-2, including a user device (e.g., the user device 110), a server (e.g., the server 120), and a database (e.g., the database 130). The method 300 may include, but not limited to, the following steps.

In step 305, the server may create one or more virtual budgeting buckets. For example, a user of the user device may have a financial account managed by a financial institution (e.g., a bank) associated with the server. The user desires to set up one or more virtual budgeting buckets associated with the financial account for setting aside certain funds in each of the one or more virtual budgeting buckets for different financial purposes or goals, for example, paying rent, grocery shopping, medical bill payment, and the like. The user may log into the financial account on the user device and send a request to the server for creating one or more virtual budgeting buckets. Upon receiving the request, the server creates the one or more virtual budgeting buckets, and associates them with the financial account of the user. The server may further store the created one or more virtual budgeting buckets in the database.

In step 310, the server may receive funds for the created virtual budgeting buckets. For example, after the virtual buckets have been successfully created, the user may want to deposit certain money to one or more of the virtual buckets. The user may transfer the funds from one or more other financial accounts that may or may not be associated with the financial institution. The user may also transfer the funds from the financial account (e.g., a checking account or a saving account) managed by the financial institution. The user may send a request through the user device to the server requesting that how much money will go into which bucket. Upon receiving the funds and the request, the server distributes the funds to the one more designated buckets.

In step 315, the server monitors and detects engagement data of the user with the virtual budgeting buckets. For example, the server may compare the cashflow of the user against the cash flow of the user's previous times to see if the user deposits some money into one or more of the buckets at the end of each month, monitor how the user's bills are paid through those buckets, determine if the user actually has some net surplus in each of the buckets, and the like. Those can be an indicator of whether this user will continue to accumulate more money in the buckets. Those data can also be a signal for the server to see if there is a behavior change prior and after, whether those behavior changes are sustained over a certain period of time. That would be a better indicator of this user having cash on hand to be considered as surplus cash, so that the server can extend certain credit to the user with a higher confidence with the ability to pay.

In step 320, the server determines whether the user meets goals of virtual budgeting buckets. The server may monitor whether the user in fact achieves his/her budgeting goals. For example, if the fund in one bucket is surplus compared to the goal of that bucket (e.g., $3,000 actual versus $2,000 goal), then the server determines that the user meet his/her goal for that bucket (e.g., completeness of goal). Similarly, if the fund in one bucket is deficit compared to the goal of that bucket (e.g., $2,000 actual versus $3,000 goal), then the server determines that the user did not meet his/her goal for that bucket (e.g., non-completeness of goal, 60% completeness of goal, or the like). As another example, for a rent bucket, there may have a transaction history that demonstrates the required rent is $2,000 a month and the rent bucket has $2,200 in it every month, so at the end of every month there is a $2,000 withdrawal at the beginning of the next month, then the goal for the rent bucket can be considered as being met or surplus.

In step 325, the server provides a predictive model (PM). The predictive model may include one or more machine learning models. The one or more machine learning models can include, but are not limited to, supervised machine learning models, unsupervised machine learning models, and so forth.

In step 330, the server input the engagement data and completeness of goals into the PM. That is, the PM ingests the engagement data and completeness of goals. The PM may also be trained or refined using the engagement data and completeness of goals.

In step 335, the PM determines a creditworthiness for the user based on the ingested engagement data and completeness of goals. The PM may combine the engagement data and the completeness of goals with the traditional credit scores (e.g., FICO score) and/or whether the user attends financial education to determine the creditworthiness.

In step 340, the server uses the predictive model to determine a credit line based on the creditworthiness for the user and provide the credit line to the user via the user device. For example, the credit line may be an initial credit line having a low credit limit. If the PM is refined using the ingested engagement data and completeness of goals, the credit line may be an updated or adjusted credit line.

After the credit line is provided, the server may continue to detect changes to the engagement data, feed the changes into the predictive model to generate another creditworthiness, and adjust the credit line based on the another creditworthiness. For example, after six month worth of data observed for the buckets, the server may determine to extend the user a $300 initial credit line even though the user's FICO score is low, because the server determines the user's budgetary behaviors are good enough from the six month worth of data. As the user continues to engage with the buckets and more data are accumulated by the server, the server may determine to pull back all those credits that were extended to the user because the server may determine that the user is no longer exhibiting good budgeting behaviors. Similarly, the server may detect that the user continues to exhibit better budgeting behaviors, continuously meets the goals, and/or set aside money for a rainy day or for other purposes, the server then determines to retain the previous credit lines or offer an increased credit line because the server may consider those behavior data to be equivalent of a much higher credit score. Thus, the server may proactively increase the credit lines of the user. With this sort of continuous real time monitoring, the server is able to make those credit line adjustments continuously.

In some embodiments, the server monitors the features of the virtual buckets. The features may include how many buckets the user is creating, the type the buckets are, and/or how many times the user is logging in. For example, when the user creates a virtual bucket, the user has the option to label/name it (e.g., the type of the bucket). The user can label it as rent, emergency, subscription bills, or other names. The server may make some recommendations based on the user's financial transaction data. For example, the user may spend $100 on UberEats, or Netflix subscriptions, the server can then recommend the user to create one or more buckets for such items, so the user can proactively create a number of buckets for different things. As it gets closer to holiday seasons, the suer may need a holiday gift bucket, so the server can look at the common spending needs of the user and recommend corresponding gift buckets.

In some embodiments, the predictive model may be continually trained. For example, the predictive model may initially start with the user behavior data and the bucket features observed over a time period of six months as a baseline. The predictive model may then continually use data observed over a time period of next six months compared to the prior six months, so the predictive model is able to determine which consumers, based on what sort of those data are more likely to have a surplus. Through continuing trainings, the predictive model is becoming more capable of predicting which of those variables of the data are more important in driving a surplus or at least a cashflow positive for certain consumers. Once the server is able to better identify consumers that have good budgeting behaviors and start to extend a credit line to them, from that point on, the server is then able to observe how the consumers are using the credit lines, how they are paying back on time, and so forth. Therefore, the predictive model can determine which user behaviors are likely to drive a better creditworthiness and then just extend it to more consumers and use more data to refine the predictive model.

In some embodiments, the users/consumers may be categorized through the predictive model into different groups. For example, the server may log a lot of different types of events that are triggered by users, such as, when the user creates the buckets, when they transfer some money, or some automated money transfer, based on which the predictive model can be built and trained. As the server collects more data, the predictive model is going to get refined and based off of that the predictive model can predict future signs of whether a user is within a certain group of users that are predefined, such as, mostly likely to pay off this certain amount or most likely to save a certain amount. All of that data over a period of time can be used to categorize users and help the predictive model refined.

As such, the method 300 provides a method implemented in an automatic system to: upon receiving a bucket creation request from a user device, create one or more virtual budgeting buckets associated with a user account of a user of the user device; receive a certain amount of fund in at least one of the one or more virtual budgeting buckets; detect engagement data of the user with the one or more virtual budgeting buckets; determine, based on the engagement data, whether the user meets goals of the one or more virtual budgeting buckets; provide a predictive model; input the engagement data and completeness of the goals into the predictive model; determine a creditworthiness of the user based on the predictive model; and provide a credit line to the user based on the creditworthiness.

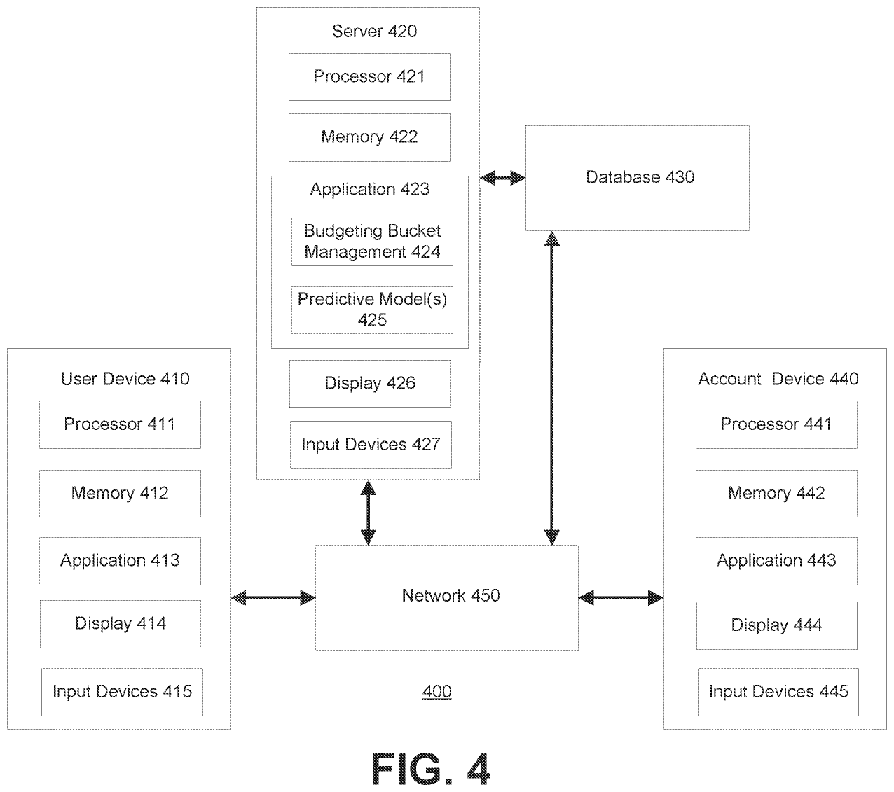

In some embodiments, a user may have another financial account in addition to the financial account managed by the server 120. The another financial account may be associated with another financial institution and managed by another server that is different than the server 120. The financial data (such as spending history, payment history) of the another financial account may also be used by the server 120 and the predictive model to determine the creditworthiness and credit line of the user. FIG. 4 illustrates a diagram of a system 400 for automatically underwriting credit lines based on granular budgeting behavior data and also the financial data of another financial account, according to an example embodiment. As further discussed below, the system 400 may include a user device 410, a server 420, a database 430, and an account device 440 (associated with another financial institution) in communication using a network 450. Although FIG. 4 illustrates single instances of the components, the system 400 may include any number of components.

The user device 410 can be associated with a user and may be operated by that user, such as a consumer. The server 420 can be associated with a first financial institution. The user of the user device may have a first financial account associated with the first financial account and managed by the server 420. The server 420 may create one or more budgeting buckets for the user upon receiving a request of creating the one or more budgeting buckets from the user, and further associate the one or more budgeting buckets with the first financial account. The account device 440 can be associated with a second financial institution. The user of the user device may have a second financial account associated with the second financial account and managed by the account device 440. The server 420 may receive, retrieve or request financial history data of the user associated with the second financial account from the account device 440, and determine a credit worthiness and credit line for the user based on the financial history data of the user associated with the second financial account.

The user device 410 and account device 440 may each be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a smart card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 410 and account device 440 may respectively include a processor 411 and 441, a memory 412 and 442, an application 413 and 443, a display 414 and 444, and input devices 415 and 445. The processor 411 and 441 may be a processor, a microprocessor, or other processor, and the user device 410 and account device 440 may each include one or more of these processors. The processor 411 and 441 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 411 and 441 may be coupled to the memory 412 and 442, respectively. The memory 412 and 442 may each be a read-only memory, write-once read-multiple memory or read/write memory, e.g., RAM, ROM, and EEPROM, and the user device 410 and account device 440 may each include one or more of these memories. A read-only memory may be factory programmable as read-only or one-time programmable. One-time programmability provides the opportunity to write once then read many times. A write-once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 412 and 442 may each be configured to store one or more software applications, such as application 413 and 443 respectively, and other data, such as private and personal information.

The application 413 and 443 may each comprise one or more software applications comprising instructions for execution on the user device 410 and account device 440 respectively. In some examples, the user device 410 and account device 440 may each execute one or more applications, such as software applications, that enable, for example, network communications with one or more components of the system 400, transmit and/or receive data, and perform the functions described herein such as video calls. Upon execution by the processor 411 and 441 respectively, the application 413 and 443 may each provide the functions described in this specification, specifically to execute and perform the steps and functions in the process flows described below. Such processes may be implemented in software, such as software modules, for execution by computers or other machines. The application 413 and 443 may each provide graphic user interfaces (GUIs) through which users may view and interact with other components and devices within the system 400. The GUIs may be formatted, for example, as web pages in HyperText Markup Language (HTML), Extensible Markup Language (XML) or in any other suitable form for presentation on a display device depending upon applications used by users to interact with the system 400.

The user device 410 and account device 440 may respectively further include a display 414 and 444 and input devices 415 and 445. The display 414 and 444 may each be any type of device for presenting visual information such as a computer monitor, a flat panel display, and a mobile device screen, including liquid crystal displays, light-emitting diode displays, plasma panels, and cathode ray tube displays. The input devices 415 and 445 may each include any device for entering information into the user device 410 and account device 440 respectively that is available and supported by the user device 410 and account device 440 respectively, such as a touch-screen, keyboard, mouse, cursor-control device, touch-screen, microphone, digital camera, video recorder or camcorder. These devices may be used to enter information and interact with the software and other devices described herein.

The server 420 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a smart card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 420 may include a processor 421, a memory 422, and an application 423. The processor 421 may be a processor, a microprocessor, or other processor, and the server 420 may include one or more of these processors. The processor 421 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 421 may be coupled to the memory 422. The memory 422 may be a read-only memory, write-once read-multiple memory or read/write memory, e.g., RAM, ROM, and EEPROM, and user deice may include one or more of these memories. A read-only memory may be factory programmable as read-only or one-time programmable. One-time programmability provides the opportunity to write once then read many times. A write-once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 422 may be configured to store one or more software applications, such as the application 423, and other data, such as consumer's spending and financial account information.

The application 423 may comprise one or more software applications comprising instructions for execution on the server 420. In some examples, the server 420 may execute one or more applications, such as software applications, that enable, for example, network communications with one or more components of the system 400, transmit and/or receive data, and perform the functions described herein. Upon execution by the processor 421, the application 423 may provide the functions described in this specification, specifically to execute and perform the steps and functions in the process flows described below. For example, the application 423 may include budgeting bucket management 424 and predictive models 425 to automatically underwrite a credit line to a user. Such processes may be implemented in software, such as software modules, for execution by computers or other machines. The application 423 may provide graphic user interfaces (GUIs) through which user may view and interact with other components and devices within the system 400. The GUIs may be formatted, for example, as web pages in HyperText Markup Language (HTML), Extensible Markup Language (XML) or in any other suitable form for presentation on a display device depending upon applications used by users to interact with the system 400.

The server 420 may further include a display 426 and input devices 427. The display 426 may be any type of device for presenting visual information such as a computer monitor, a flat panel display, and a mobile device screen, including liquid crystal displays, light-emitting diode displays, plasma panels, and cathode ray tube displays. The input devices 427 may include any device for entering information into the server 420 that is available and supported by the server 420, such as a touch-screen, keyboard, mouse, cursor-control device, touch-screen, microphone, digital camera, video recorder or camcorder. These devices may be used to enter information and interact with the software and other devices described herein.

The database 430 may be one or more databases configured to store date, including without limitation, private information of consumers, credit card data, virtual budgeting buckets. The database 430 may comprise a relational database, a non-relational database, or other database implementations, and any combination thereof, including a plurality of relational databases and non-relational databases. In some examples, the database 430 may comprise a desktop database, a mobile database, or an in-memory database. Further, the database 430 may be hosted internally by the server 420 or may be hosted externally of the server 420, such as by a server, by a cloud-based platform, or in any storage device that is in data communication with the server 420.

The system 400 may include one or more networks 450. In some examples, the network 450 may be one or more of a wireless network, a wired network or any combination of wireless network and wired network, and may be configured to connect the user device 410, the server 420, the database 430, and the account device 440. For example, the network 450 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.44b, 802.45.4, 802.44n and 802.44g, Bluetooth, NFC, Radio Frequency Identification (RFID), Wi-Fi, and/or the like.

In addition, the network 450 may include, without limitation, telephone lines, fiber optics, IEEE Ethernet 902.3, a wide area network, a wireless personal area network, a LAN, or a global network such as the Internet. In addition, the network 450 may support an Internet network, a wireless communication network, a cellular network, or the like, or any combination thereof. The network 450 may further include one network, or any number of the exemplary types of networks mentioned above, operating as a stand-alone network or in cooperation with each other. The network 450 may utilize one or more protocols of one or more network elements to which they are communicatively coupled. The network 450 may translate to or from other protocols to one or more protocols of network devices. Although the network 450 is depicted as a single network, it should be appreciated that according to one or more examples, the network 450 may comprise a plurality of interconnected networks, such as, for example, the Internet, a service provider's network, a cable television network, corporate networks, such as credit card association networks, and home networks. The network 450 may further comprise, or be configured to create, one or more front channels, which may be publicly accessible and through which communications may be observable, and one or more secured back channels, which may not be publicly accessible and through which communications may not be observable.

In some examples, communications between the user device 410, server 420, and account device 440 using network 450 can occur using one or more front channels and one or more secure back channels. A front channel may be a communication protocol that employs a publicly accessible and/or unsecured communication channel such that a communication sent to the user device 410, server 420, and/or account device 440 may originate from any other device, whether known or unknown to the user device 410, server 420, and/or the account device 440, if that device possesses the address (e.g., network address, Internet Protocol (IP) address) of the user device 410, server 420, and/or the account device 440. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the user device 410, server 420, and/or the account device 440 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

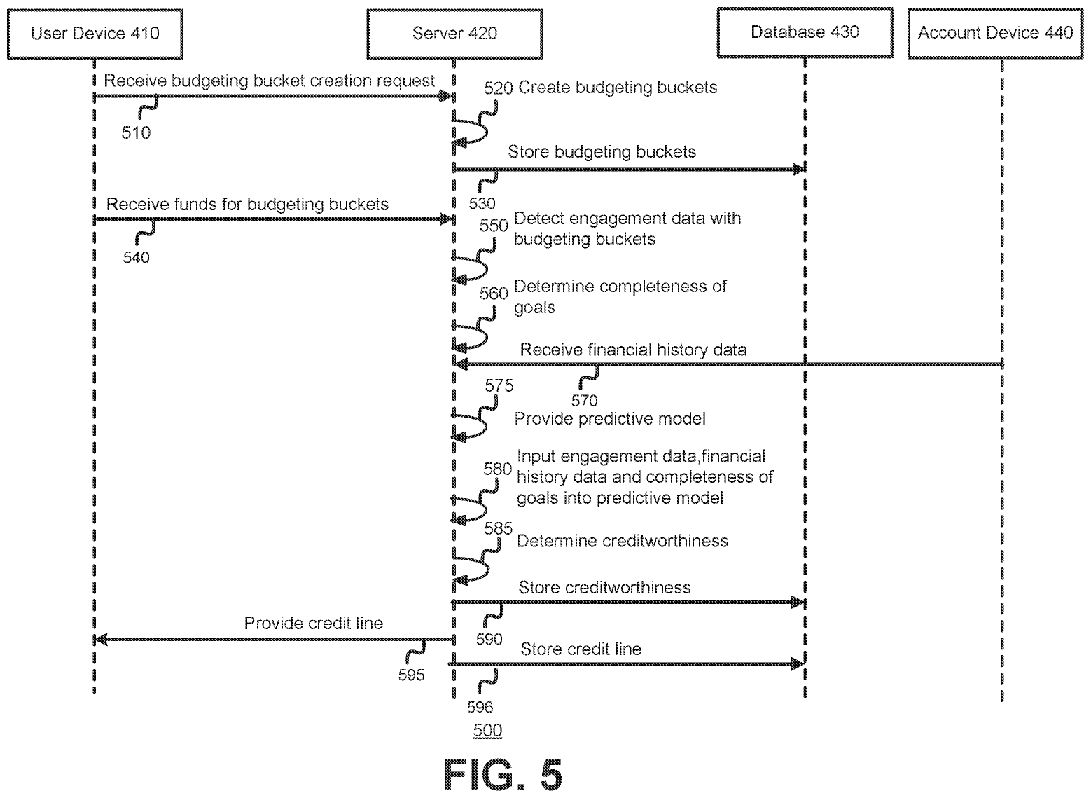

FIG. 5 illustrates a diagram illustrating interactions of components of the system 400 of FIG. 4 according to an example embodiment. FIG. 5 may reference the same or similar components as those illustrated in FIG. 4, including a user device 410, a server 420, a database 430, and an account device 440.

When a user, for example, a bank consumer of the first financial institution managed by the server 420, may desire to create one or more virtual budgeting buckets as a potential budgeting tool, the user may transmit a budgeting bucket creation request from the user device 410 to the server 420, and accordingly at 510 the server 420 receives the request. The budgeting bucket creation request may include the number of buckets to be created and the type of the buckets to be created. The user may first be required to login to the first financial account managed by the server 420 in an application installed on the user device 410, and then transmit the budgeting bucket creation request through the application to the server 420.

At 520, the server 420 creates one or more budgeting buckets according to the received request. For example, a first bucket is created and labeled as “emergency,” a second bucket is created and labeled as “medical bill,” a third bucket is created and labeled as “grocery,” and the like. These buckets are created under the first financial account of the user and are associated with the first financial account. At 530, the server 420 stores the created one or more budgeting buckets in the database 430 under the first financial account of the user.

The user can set aside money for different purposes in the created budgeting buckets according to the names/labels of the budgeting buckets. At 540, the user may transmit funds to the server 420 through the application on the user device 410 for the buckets, and accordingly, the server 420 receives the funds for the buckets, and deposit/distribute the funds into the buckets. For example, the user may transmit $4,000 total and designate $2,000 towards a “vacation” bucket, and $2,000 towards an “emergency” bucket. In this way, the systems and methods disclosed herein can help the user be financially responsible or disciplined in terms of how the user spends his/her money. In some embodiments, the user may transmit funds from the second financial account managed by the account device 440 to the server 420 through the application on the user device 410 for the buckets.

Once the buckets are created and furnished with funds, at 550, the server 420 can monitor and detect engagement data of the user with the budgeting buckets. For example, the behavior data of the user's interactions with the buckets are monitored; how and when the user spends the money in the bucket is monitored; the way the user moves his/her different money into and/or out of the buckets is detected and evaluated; and the like.

At 560, the server 420 may determine completeness of financial goals of the buckets. The server 420 may monitor whether the user in fact achieves his/her budgeting goals, whether the funds in the buckets are surplus or deficit compared to the goals or the target date of the goals. For example, for a rent bucket, there may have a transaction history that demonstrates the rent is $1,000 a month and the rent bucket has $1,200 in it every month. At the end of every month there is a $1,000 withdrawal at the beginning of the next month, the goal can be considered as being met or surplus.

At 570, the server 420 may receive, retrieve or request financial history data of the user associated with the second financial account from the account device 440. The server 420 may request a permission from the user to retrieve such financial history data. The financial history data of the user associated with the second financial account may include, but is not limited to, payment history, account balance, credit line, auto loan, mortgage, spending behaviors, and the like.

At 575, the server 420 provides a predictive model. The predictive model may be a machine learning model. The machine learning model employed can include at least one selected from the group of gradient boosting machine, logistic regression, neural networks, supervised learning, unsupervised learning, and a combination thereof, however, it is understood that other machine learning algorithms can be utilized.

The predictive models described herein can be trained on one or more training datasets, each of which can comprise one or more types of data. In some examples, the training datasets can comprise previously-collected data, such as data collected from previous uses of the same type of systems described herein and data collected from different types of systems. In other examples, the training datasets can comprise continuously-collected data based on the current operation of the instant system and continuously-collected data from the operation of other systems. In some examples, the training dataset can include anticipated data, such as the anticipated future events, currently scheduled events, and planned future events, for the instant system and/or other systems. In other examples, the training datasets can include previous predictions for the instant system and other types of system, and can further include results data indicative of the accuracy of the previous predictions. In accordance with these examples, the predictive models described herein can be training prior to use and the training can continue with updated data sets that reflect additional information.

Examples of predictive models that may be implemented include a hidden Markov model, a Gaussian mixture model, a pattern matching algorithm, a neural network, a matrix representation, (a vector quantization and decision tree, a supervised learning model, an unsupervised learning model, a semi-supervised learning model, a reinforcement learning model, a self-learning model, and a feature learning model).

At 580, the engagement data, financial history data of the user associated with the second financial account, and the completeness of goals are fed into the predictive model by the server 420. At 585, the predictive model determines a creditworthiness for the user based on the engagement data, financial history data of the user associated with the second financial account, and the completeness of goals. In some embodiments, the predictive model may combine the engagement data, financial history data of the user associated with the second financial account, and the completeness of goals with the traditional credit scores (e.g., FICO score) and/or whether the user attends financial education to determine the creditworthiness.

At 590, the server 420 may store the determined creditworthiness in the database 430. At 595, the server 420 uses the predictive model to determine a credit line based on the creditworthiness for the user and provide the credit line to the user via the user device 410. For example, the credit line may be an initial credit line having a low credit limit. At 596, the server 420 may store the credit line in the database 430 and associate the credit line with the first financial account of the user.

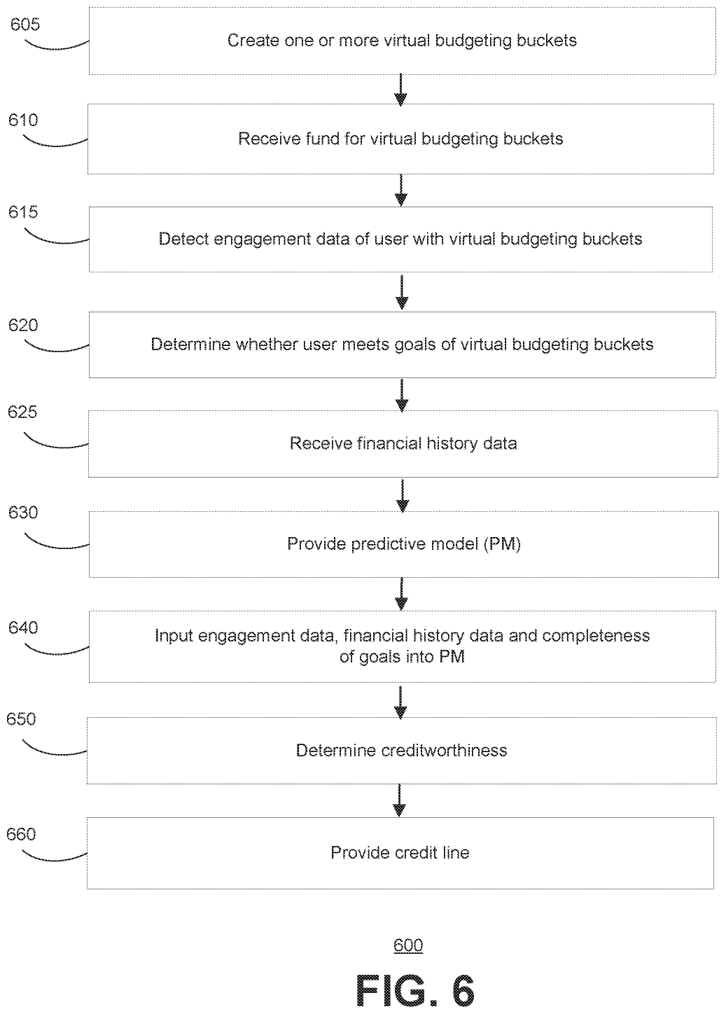

FIG. 6 is a flow chart illustrating a method 600 of automatically underwriting credit lines based on granular budgeting behavior data and financial history data of the user associated with another financial account according to an example embodiment. FIG. 6 may reference the same or similar components as those illustrated in FIGS. 4-5, including a user device (e.g., the user device 410), a server (e.g., the server 420), a database (e.g., the database 430), and an account device (the account device 440). The method 600 may include, but is not limited to, the following steps.

In step 605, the server may create one or more virtual budgeting buckets. For example, a user of the user device may have a first financial account managed by a first financial institution (e.g., a bank) associated with the server. The user desires to set up one or more virtual budgeting buckets associated with the first financial account for setting aside certain funds in each of the one or more virtual budgeting buckets for different financial purposes or goals, for example, paying rent, grocery shopping, medical bill payment, and the like. The user may log into the first financial account on the user device and send a request to the server for creating one or more virtual budgeting buckets. Upon receiving the request, the server creates the one or more virtual budgeting buckets, and associates them with the first financial account of the user. The server may further store the created one or more virtual budgeting buckets in the database.

In step 610, the server may receive funds for the created virtual budgeting buckets. For example, after the virtual buckets have been successfully created, the user may want to deposit certain money to one or more of the virtual buckets. The user may transfer the funds from one or more other financial accounts (such as the second financial account managed by the account device 440) that may or may not be associated with the first financial institution. The user may also transfer the funds from the first financial account (e.g., a checking account or a saving account) managed by the first financial institution. The user may send a request through the user device to the server requesting that how much money will go into which bucket. Upon receiving the funds and the request, the server distributes the funds to the one more designated buckets.

In step 615, the server monitors and detects engagement data of the user with the virtual budgeting buckets. For example, the server may compare the cashflow of the user against the cash flow of the user's previous times to see if the user deposits some money into one or more of the buckets at the end of each month, monitor how the user's bills are paid through those buckets, determine if the user actually has some net surplus in each of the buckets, and the like. Those can be an indicator of whether this user will continue to accumulate more money in the buckets. Those data can also be a signal for the server to see if there is a behavior change prior and after, whether those behavior changes are sustained over a certain period of time. That would be a better indicator of this user having cash on hand to be considered as surplus cash, so that the server can extend certain credit to the user with a higher confidence with the ability to pay.

In step 620, the server determines whether the user meets goals of virtual budgeting buckets. The server may monitor whether the user in fact achieves his/her budgeting goals. For example, if the fund in one bucket is surplus compared to the goal of that bucket (e.g., $3,500 actual versus $3,000 goal), then the server determines that the user meet his/her goal for that bucket (e.g., completeness of goal). Similarly, if the fund in one bucket is deficit compared to the goal of that bucket (e.g., $2,000 actual versus $2,500 goal), then the server determines that the user did not meet his/her goal for that bucket (e.g., non-completeness of goal, 50% completeness of goal, or the like). As another example, for a rent bucket, there may have a transaction history that demonstrates the required rent is $1,000 a month and the rent bucket has $1,200 in it every month, so at the end of every month there is a $1,000 withdrawal at the beginning of the next month, then the goal for the rent bucket can be considered as being met or surplus.

In step 625, the server may receive, retrieve or request financial history data of the user associated with the second financial account from the account device. The server may request a permission from the user to retrieve such financial history data. The financial history data of the user associated with the second financial account may include, but is not limited to, payment history, account balance, credit line, auto loan, mortgage, spending behaviors, and the like

In step 630, the server provides a predictive model (PM). The predictive model may include one or more machine learning models. The one or more machine learning models can include, but are not limited to, supervised machine learning models, unsupervised machine learning models, and so forth.

In step 640, the server input the engagement data, the financial history data associated with the second financial account, and completeness of goals into the PM. That is, the PM ingests the engagement data, the financial history data associated with the second financial account, and the completeness of goals. The PM may also be trained or refined using the engagement data, financial history data associated with the second financial account, and completeness of goals.

In step 650, the PM determines a creditworthiness for the user based on the ingested engagement data, financial history data associated with the second financial account, and completeness of goals. The PM may combine the engagement data, financial history data associated with the second financial account, and the completeness of goals with the traditional credit scores (e.g., FICO score) and/or whether the user attends financial education to determine the creditworthiness.

In step 660, the server uses the predictive model to determine a credit line based on the creditworthiness for the user and provide the credit line to the user via the user device. For example, the credit line may be an initial credit line having a low credit limit. If the PM is refined using the ingested engagement data, financial history data associated with the second financial account, and completeness of goals, the credit line may be an updated or adjusted credit line.

As described above, the credit score (e.g., FICO score) or any other existing data associated with the user can be used as the initial data for determining whether a credit line is underwritten for the user, in addition to which, the behavior data of the user that are recorded from the buckets are gradually combined to adjust the credit line. The systems and methods disclosed herein can identify the top performers versus the bottom performers among consumers based on the behavior data of consumers. The top performers are people who really stick with the budgeting goals they set. They meet the goals and at the end of the day they have surplus, and they are cashflow positive that helps them spend less and have more savings. The systems and methods disclosed herein can identify what is separating the top performers and the bottom performers. This may be more about the number of times, or the number of buckets they created or may be more about the completeness of goals (such as, are they able to meet those goals, like 80%, 90%). Initial credit lines may be extended to those top performers.

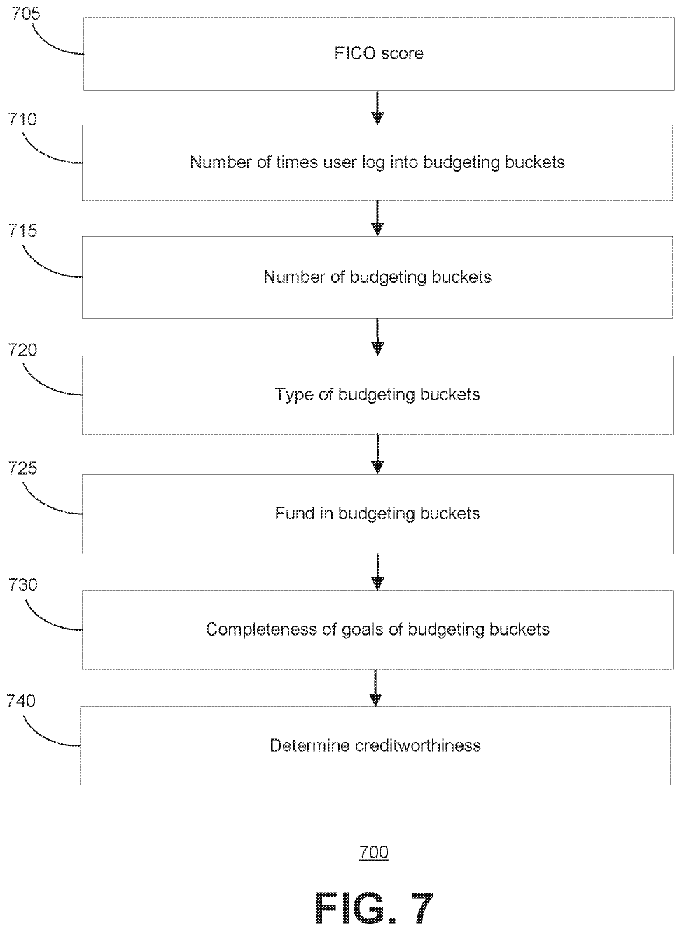

As described above, the predictive model may include one or more machine learning models for determining a creditworthiness and/or credit line for a user. FIG. 7 describes an example method 700 of determining a creditworthiness using a machine learning model based on credit affecting factors according to an example embodiment. FIG. 7 may reference the same or similar components as those illustrated in FIGS. 1-6, including a user device, a server, a database, and an account device. The method 700 may include, but is not limited to the following steps.

In step 705, a credit score (e.g., FICO score) of a user is received into the machine learning model. In step 710, the number of times the user logs into budgeting buckets (such as on a daily basis, a weekly basis, or a monthly basis) is received into the machine learning model. In step 715, the number of budgeting buckets (such as 3 buckets created, 5 buckets created) is received into the machine learning model. In step 720, the type of budgeting buckets (such as rent, medical bill, grocery) is received into the machine learning model. In step 725, the fund in each of the budgeting buckets is received into the machine learning model. In step 730, the completeness goals of budgeting buckets is received into the machine learning model. And in step 735, the machine learning model determines a creditworthiness for the user based on the above received factors/parameters.

In some embodiments, the completeness of the goals comprises one or more of how often the user meets the goals, how much surplus the user has with the goals, how much deficit the user has with the goals, or target dates of the goals.

The present disclosure provide systems and methods of continually underwriting credit lines by leveraging granular user budgeting behavior data and traditional credit line underwriting data (e.g., a FICO score). When a user and/or consumer is new to credit so the credit bureaus do not have a lot of history on that because the user and/or consumer never used a credit card or other credit product before. Also if a user or consumer only recently starts using a credit card or other credit product, the user has very little credit history. As such, it is hard to rely on a credit score (e.g., FICO score) to underwrite a credit line for a user and/or consumer. The present disclosure enhances those traditional data with added additional behavior data observed from consumers using the bucket features to budget whether they meet the goal of their budget, and/or how they spend their money. By leveraging the observed behavior data, those consumers can be underwritten an initial credit line even though their credit scores (e.g., FICO scores) are not high enough. Further, by continuously underwriting consumers based on their ongoing behaviors, such as the way they manage their budgets, the way they move their different money and how successful they are in meeting those budgetary goals they have set for themselves, the initial credit line can be adjusted (e.g., continually increased), which will help the consumers to build or rebuild their credit.

The systems and methods of the present disclosure also provide advantages to credit-issuing entities, such as financial institutions. By effectively considering and extending credit to users and/or consumers that are new to credit cards or other credit products, have limited credit histories, and may need to rebuild credit, the credit-issuing entity may identify and obtain new credit accounts, begin relationships with new users and/or consumers, and/or expand the relationship with existing users and/or consumers.

In some aspects, the techniques described herein relate to an automatic system including a server, the server configured to: upon receiving a bucket creation request from a user device, create one or more virtual budgeting buckets associated with a user account of a user of the user device; receive a certain amount of fund in at least one of the one or more virtual budgeting buckets; detect engagement data of the user with the one or more virtual budgeting buckets; determine, based on the engagement data, whether the user meets goals of the one or more virtual budgeting buckets; provide a predictive model; input the engagement data and completeness of the goals into the predictive model; determine a creditworthiness of the user based on the predictive model; and provide a credit line to the user based on the creditworthiness.

In some aspects, the techniques described herein relate to a system, wherein the server is further configured to: detect changes to the engagement data; feed the changes into the predictive model to generate another creditworthiness; and adjust the credit line based on the another creditworthiness.

In some aspects, the techniques described herein relate to a system, wherein the action of determine a creditworthiness of the user is further based on one or more of a Fair Isaac Corporation (FICO) score of the user, a financial education through a credit score simulator the user attends, or a financial education through a video the user watches.

In some aspects, the techniques described herein relate to a system, wherein the engagement data include one or more of a number of times the user logs into the one or more virtual budgeting buckets, a number of the one or more virtual budgeting buckets, a type of the one or more virtual budgeting buckets, or a fund in each of the one or more virtual budgeting buckets.

In some aspects, the techniques described herein relate to a system, wherein the server is further configured to identify factors affecting the completeness of the goals, and refine the predictive model based on the factors.

In some aspects, the techniques described herein relate to a system, wherein the completeness of the goals includes one or more of how often the user meets the goals, how much surplus the user has with the goals, how much deficit the user has with the goals, or target dates of the goals.

In some aspects, the techniques described herein relate to a system, wherein the server is further configured to receive financial history data of the user from another financial account of the user, and the action of determine a creditworthiness of the user is further based on the financial history data.

In some aspects, the techniques described herein relate to a method, including: upon receiving a bucket creation request from a user device, creating, by a server, one or more virtual budgeting buckets associated with a user account of a user of the user device; receiving, by the server, a certain amount of fund in at least one of the one or more virtual budgeting buckets; detecting, by the server, engagement data of the user with the one or more virtual budgeting buckets; determining, by the server based on the engagement data, whether the user meets goals of the one or more virtual budgeting buckets; providing, by the server, a predictive model; inputting, by the server, the engagement data and completeness of the goals into the predictive model; determining, by the server, a creditworthiness of the user based on the predictive model; and providing, by the server, a credit line to the user based on the creditworthiness.

In some aspects, the techniques described herein relate to a method, further including: detecting, by the server, changes to the engagement data; feeding, by the server, the changes into the predictive model to generate another creditworthiness; and adjusting, by the server, the credit line based on the another creditworthiness.

In some aspects, the techniques described herein relate to a method, wherein the action of determining a creditworthiness of the user is further based on one or more of a Fair Isaac Corporation (FICO) score of the user, a financial education through a credit score simulator the user attends, or a financial education through a video the user watches.

In some aspects, the techniques described herein relate to a method, wherein the engagement data include one or more of a number of times the user logs into the one or more virtual budgeting buckets, a number of the one or more virtual budgeting buckets, a type of the one or more virtual budgeting buckets, or a fund in each of the one or more virtual budgeting buckets.

In some aspects, the techniques described herein relate to a method, further including identifying factors affecting the completeness of the goals, and refining the predictive model based on the factors.

In some aspects, the techniques described herein relate to a method, wherein the completeness of the goals includes one or more of how often the user meets the goals, how much surplus the user has with the goals, how much deficit the user has with the goals, or target dates of the goals.

In some aspects, the techniques described herein relate to a method, further including receiving, by the server, financial history data of the user from another financial account of the user, and the action of determining a creditworthiness of the user is further based on the financial history data.

In some aspects, the techniques described herein relate to a non-transitory, computer-accessible medium including instructions that, when executed on a server, configure the server to perform actions including: upon receiving a bucket creation request from a user device, creating one or more virtual budgeting buckets associated with a user account of a user of the user device; receiving a certain amount of fund in at least one of the one or more virtual budgeting buckets; detecting engagement data of the user with the one or more virtual budgeting buckets; determining, based on the engagement data, whether the user meets goals of the one or more virtual budgeting buckets; providing a predictive model; inputting the engagement data and completeness of the goals into the predictive model; determining a creditworthiness of the user based on the predictive model; and providing a credit line to the user based on the creditworthiness.

In some aspects, the techniques described herein relate to a non-transitory, computer-accessible medium, wherein the actions further include: detecting changes to the engagement data; feeding the changes into the predictive model to generate another creditworthiness; and adjusting the credit line based on the another creditworthiness.

In some aspects, the techniques described herein relate to a non-transitory, computer-accessible medium, wherein the action of determining a creditworthiness of the user is further based on one or more of a Fair Isaac Corporation (FICO) score of the user, a financial education through a credit score simulator the user attends, or a financial education through a video the user watches.

In some aspects, the techniques described herein relate to a non-transitory, computer-accessible medium, wherein the engagement data include one or more of a number of times the user logs into the one or more virtual budgeting buckets, a number of the one or more virtual budgeting buckets, a type of the one or more virtual budgeting buckets, or a fund in each of the one or more virtual budgeting buckets.

In some aspects, the techniques described herein relate to a non-transitory, computer-accessible medium, wherein the actions further include identifying factors affecting the completeness of the goals, and refining the predictive model based on the factors.

In some aspects, the techniques described herein relate to a non-transitory, computer-accessible medium, wherein the completeness of the goals includes one or more of how often the user meets the goals, how much surplus the user has with the goals, how much deficit the user has with the goals, or target dates of the goals.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer and/or processor that can include, for example one or more microprocessors, and use instructions stored on a computer-accessible medium (e.g., RAM, ROM, hard drive, or other storage device). For example, a computer-accessible medium can be part of the memory of the user device 110, the server 120 or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example. For example, a non-transitory, computer-accessible medium is provided comprising instructions that, when executed on a server, configure the server to perform actions comprising: upon receiving a bucket creation request from a user device, creating one or more virtual budgeting buckets associated with a user account of a user of the user device; receiving a certain amount of fund in at least one of the one or more virtual budgeting buckets; detecting engagement data of the user with the one or more virtual budgeting buckets; determining, based on the engagement data, whether the user meets goals of the one or more virtual budgeting buckets; providing a predictive model; inputting the engagement data and completeness of the goals into the predictive model; determining a creditworthiness of the user based on the predictive model; and providing a credit line to the user based on the creditworthiness.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An automatic system comprising a server, the server configured to:
upon receiving a bucket creation request from a user device, create one or more virtual budgeting buckets associated with a user account of a user of the user device;
receive a certain amount of fund in at least one of the one or more virtual budgeting buckets;
detect engagement data of the user with the one or more virtual budgeting buckets;
determine, based on the engagement data, whether the user meets goals of the one or more virtual budgeting buckets;
provide a predictive model;
input the engagement data and completeness of the goals into the predictive model;
determine a creditworthiness of the user based on the predictive model; and
provide a credit line to the user based on the creditworthiness.

2. The system of claim 1, wherein the server is further configured to:
detect changes to the engagement data;
feed the changes into the predictive model to generate another creditworthiness; and
adjust the credit line based on the another creditworthiness.

3. The system of claim 1, wherein the action of determine a creditworthiness of the user is further based on one or more of a Fair Isaac Corporation (FICO) score of the user, a financial education through a credit score simulator the user attends, or a financial education through a video the user watches.

4. The system of claim 1, wherein the engagement data comprise one or more of a number of times the user logs into the one or more virtual budgeting buckets, a number of the one or more virtual budgeting buckets, a type of the one or more virtual budgeting buckets, or a fund in each of the one or more virtual budgeting buckets.

5. The system of claim 1, wherein the server is further configured to identify factors affecting the completeness of the goals, and refine the predictive model based on the factors.

6. The system of claim 1, wherein the completeness of the goals comprises one or more of how often the user meets the goals, how much surplus the user has with the goals, how much deficit the user has with the goals, or target dates of the goals.

7. The system of claim 1, wherein the server is further configured to receive financial history data of the user from another financial account of the user, and the action of determine a creditworthiness of the user is further based on the financial history data.

8. A method, comprising:
upon receiving a bucket creation request from a user device, creating, by a server, one or more virtual budgeting buckets associated with a user account of a user of the user device;
receiving, by the server, a certain amount of fund in at least one of the one or more virtual budgeting buckets;
detecting, by the server, engagement data of the user with the one or more virtual budgeting buckets;
determining, by the server based on the engagement data, whether the user meets goals of the one or more virtual budgeting buckets;
providing, by the server, a predictive model;
inputting, by the server, the engagement data and completeness of the goals into the predictive model;
determining, by the server, a creditworthiness of the user based on the predictive model; and
providing, by the server, a credit line to the user based on the creditworthiness.

9. The method of claim 8, further comprising:
detecting, by the server, changes to the engagement data;
feeding, by the server, the changes into the predictive model to generate another creditworthiness; and
adjusting, by the server, the credit line based on the another creditworthiness.

10. The method of claim 8, wherein the action of determining a creditworthiness of the user is further based on one or more of a Fair Isaac Corporation (FICO) score of the user, a financial education through a credit score simulator the user attends, or a financial education through a video the user watches.

11. The method of claim 8, wherein the engagement data comprise one or more of a number of times the user logs into the one or more virtual budgeting buckets, a number of the one or more virtual budgeting buckets, a type of the one or more virtual budgeting buckets, or a fund in each of the one or more virtual budgeting buckets.

12. The method of claim 8, further comprising identifying factors affecting the completeness of the goals, and refining the predictive model based on the factors.

13. The method of claim 8, wherein the completeness of the goals comprises one or more of how often the user meets the goals, how much surplus the user has with the goals, how much deficit the user has with the goals, or target dates of the goals.

14. The method of claim 8, further comprising receiving, by the server, financial history data of the user from another financial account of the user, and the action of determining a creditworthiness of the user is further based on the financial history data.

15. A non-transitory, computer-accessible medium comprising instructions that, when executed on a server, configure the server to perform actions comprising:
upon receiving a bucket creation request from a user device, creating one or more virtual budgeting buckets associated with a user account of a user of the user device;
receiving a certain amount of fund in at least one of the one or more virtual budgeting buckets;
detecting engagement data of the user with the one or more virtual budgeting buckets;
determining, based on the engagement data, whether the user meets goals of the one or more virtual budgeting buckets;
providing a predictive model;
inputting the engagement data and completeness of the goals into the predictive model;
determining a creditworthiness of the user based on the predictive model; and
providing a credit line to the user based on the creditworthiness.

16. The non-transitory, computer-accessible medium of claim 15, wherein the actions further comprise:
detecting changes to the engagement data;
feeding the changes into the predictive model to generate another creditworthiness; and
adjusting the credit line based on the another creditworthiness.

17. The non-transitory, computer-accessible medium of claim 15, wherein the action of determining a creditworthiness of the user is further based on one or more of a Fair Isaac Corporation (FICO) score of the user, a financial education through a credit score simulator the user attends, or a financial education through a video the user watches.

18. The non-transitory, computer-accessible medium of claim 15, wherein the engagement data comprise one or more of a number of times the user logs into the one or more virtual budgeting buckets, a number of the one or more virtual budgeting buckets, a type of the one or more virtual budgeting buckets, or a fund in each of the one or more virtual budgeting buckets.

19. The non-transitory, computer-accessible medium of claim 15, wherein the actions further comprise identifying factors affecting the completeness of the goals, and refining the predictive model based on the factors.

20. The non-transitory, computer-accessible medium of claim 15, wherein the completeness of the goals comprises one or more of how often the user meets the goals, how much surplus the user has with the goals, how much deficit the user has with the goals, or target dates of the goals.
